(19) United States
(12) Patent Application Publication
(10) Pub. No.: US 2015/0296584 A1
(43) Pub. Date: Oct. 15, 2015

(54) HIGH UTILIZATION LED DRIVER

(71) Applicant: LuxTech, LLC, Philadelphia, PA (US)

(72) Inventors: Sean R. DARRAS, Philadelphia, PA (US); Ronald J. LENK, Marietta, GA (US)

(21) Appl. No.: 14/686,331

(22) Filed: Apr. 14, 2015

Related U.S. Application Data
(60) Provisional application No. 61/979,147, filed on Apr. 14, 2014.

(51) Int. Cl. H05B 33/08

(52) U.S. Cl. CPC H05B 33/0845; H05B 33/0812

(57) ABSTRACT

A high utilization AC-line input light emitting diode driver that can automatically transition to the most favorable configuration of the LEDs based on the instantaneous line voltage input.

### CROSS-REFERENCE TO RELATED APPLICATIONS

This patent application claims priority to U.S. Provisional Patent Application No. 61/979,147 filed on Apr. 14, 2014 and entitled “High Utilization LED Driver”, the contents of which are incorporated herein by reference.

### FIELD OF THE DISCLOSURE

The present disclosure relates to providing a high utilization alternating current (AC)-line input light emitting diode (LED) driver, and more particularly, to providing a driver that automatically transitions to the most (or more) favorable configuration of the LEDs based on the instantaneous line voltage input.

### BACKGROUND

It is frequently desirable to power LEDs from the AC line. In North America, this is nominally 120VAC or 277VAC; in other parts of the world, this is nominally 240VAC. The actual line voltage may deviate from this nominal by +10% or more on a regular basis.

LEDs typically have a forward voltage while conducting current of approximately 3V. This voltage varies somewhat as a function of the drive current and temperature, typically ±20%. However, LEDs, being diodes, need to be driven with a current rather than a voltage. For this reason, LEDs are frequently driven by switch-mode power supplies (SMPS), which convert the high-voltage AC line voltage to a low-voltage current.

However, SMPS tend to be expensive, and may have relatively low lifetime compared with that of the LEDs they are driving. For this reason, some designs use a string of LEDs, with a sufficient number of LEDs in series in the string to present a forward voltage of approximately the line voltage. Some designs place the LED string directly across the AC line; however, since LEDs are unidirectional, the LEDs in this arrangement conduct only during half of each line cycle. Other designs first rectify the AC line and then apply the rectified voltage to the string of LEDs; in this arrangement, the LEDs conduct during both halves of the line cycle, thus providing double the light output of the first configuration.

However, such designs suffer from a number of problems. One of these problems is the low utilization of the LEDs, which is to say, the amount of light produced per LED is relatively low. Since the string of LEDs has a forward voltage roughly comparable with the line voltage, the LEDs don't turn on at all until a substantial fraction of the peak line voltage is reached by the AC line. They are thus off for a significant fraction of the line cycle, resulting in less light output per LED than if they were on longer. Furthermore, since the LEDs are off for a significant fraction of the line cycle, line frequency flicker may be more noticeable with this system than if they were on longer.

It would be desirable to have an AC drive circuit that conducts current through the LEDs for a larger fraction of the line cycle, to improve LED utilization and reduce flicker. It would also be desirable that it would be inexpensive and have a long lifetime.

### SUMMARY

Some embodiments described herein relate to an AC-line driver for LEDs, such that the above-described primary problem is effectively solved. An AC-line driver for LEDs can produce a certain current throughout a specified range of the instantaneous line voltage, and then re-configure to produce another certain current throughout another specified range of the instantaneous line voltage. It provides for high LED utilization and low flicker, and also provides for high efficiency, low cost and long lifetime.

In some embodiments, a rectifier bridge and two sets of strings of LEDs can be included. The first set of strings can be connected from the output of the bridge, through a controllable element such as a transistor or a current sink, to ground. The second set of strings of LEDs can be connected through a transistor to the output of the bridge, and is then connected, either directly or through a controllable element such as a transistor or a current sink, to ground. The output of the first set of strings of LEDs is, in addition to being connected to a controllable element, also connected to a diode, and potentially also to additional components as described below, which in turn connects to the input of the second set of strings of LEDs.

In such embodiments, while the instantaneous line voltage is in a first, lower, input range of the voltage, the controllable element for the first set of strings of LEDs is on, as is also the controllable element from the output of the bridge to the input to the second set of strings of LEDs. The controllable element for the second set of strings of LEDs, if present, is on in this configuration. In this configuration, both sets of strings of LEDs are connected in parallel to the output of the bridge, and are both powered on. In one embodiment, the strings of LEDs and the controllable elements are configured such that a specific current is produced in the first range of the instantaneous line voltage.

While the instantaneous line voltage is in a second, higher, input range of the line voltage, the controllable element for the first set of strings of LEDs is off, as is also the controllable element from the output of the bridge to the input to the second set of strings of LEDs. The controllable element for the second set of strings of LEDs, if present, remains on in this configuration. In this configuration, the current from the bridge goes through the first set of strings of LEDs, then through the diode and additional components if present, and then through the second set of strings of LEDs, and thence through the controllable element, if present, to ground. In one embodiment for a 120VAC line input, the first input voltage range is 0-120V and the second input voltage range is 120V-168V.

### BRIEF DESCRIPTION OF THE DRAWINGS

The accompanying drawings are included to provide a further understanding, and are incorporated in and constitute a part of this specification.

FIG. 1a is a system block diagram of an AC-line input LED circuit 10, according to an embodiment.

FIG. 1b is an example graph showing voltage as a function of time for the AC line shown in FIG. 1a.

FIG. 2 is a diagram of an AC-line input LED circuit, in which two sets of strings of LEDs are configured to re-configure as the instantaneous line voltage from a AC source rises from one range to another, according to an embodiment.

FIG. 3 is a diagram of the AC-line input LED circuit of FIG. 2, operating in a low range of the instantaneous line voltage.

FIG. 4 is a diagram of the AC-line input LED circuit of FIG. 2, operating in a high range of the instantaneous line voltage.

### DETAILED DESCRIPTION

Reference will now be made in detail to various embodiments, examples of which are illustrated in the accompanying drawings. Wherever possible, the same reference numbers are used in the drawing and the description to refer to the same or like parts.

According to the design characteristics, a detailed description of the embodiments is given below.

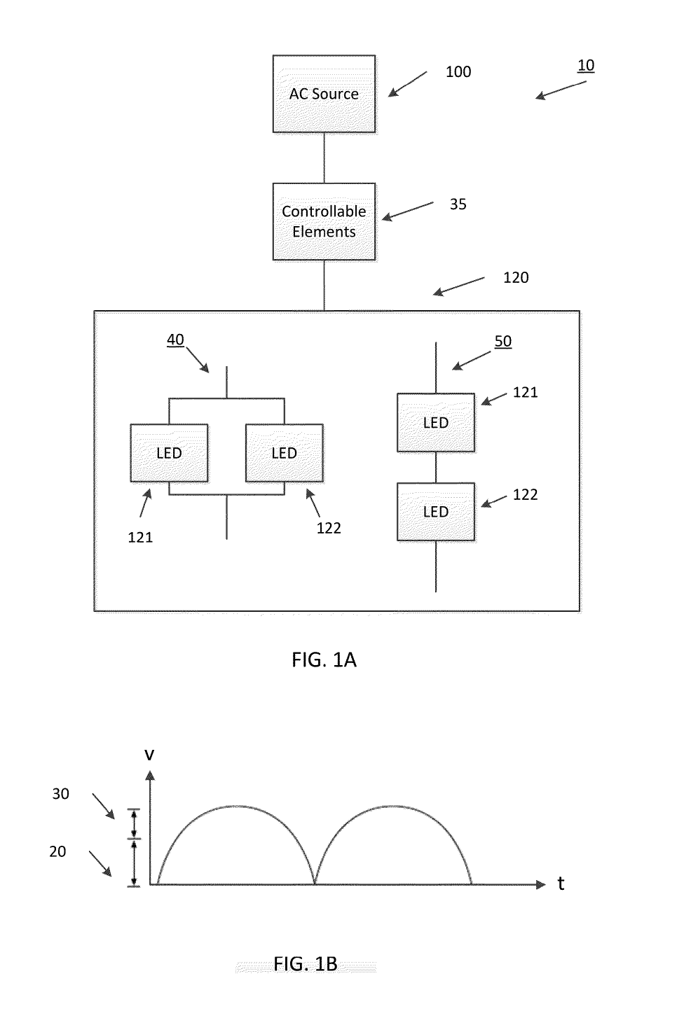

FIG. 1a is a system block diagram of an AC-line input LED circuit 10, according to an embodiment. FIG. 1b is an example graph showing voltage as a function of time for the AC line shown in FIG. 1a. The LED circuit 10 includes an AC source 100, controllable elements 35 and LED set 120, which includes for example a first string of LEDs 121 and a second string of LEDs 122. The LED set 120 can be re-configurable as a function of the input, and including configuration 40 (where the first string of LEDs 121 and second string of LEDs 122 are connected in parallel) and configuration 50 (where the first string of LEDs 121 and second string of LEDs 122 are connected in series). Although not shown, the LED circuit 10 can include a control system that is operatively coupled to the controllable elements 35, and can select the state of each controllable element 35.

As shown in FIG. 1a, two sets of strings of LEDs 40 are configured to be in parallel when the instantaneous line voltage of AC source 100 is in a low range 20 (shown in FIG. 1b), and the two sets of strings of LEDs 50 are configured to be in series when the instantaneous line voltage of AC source 100 is in a high range 30 (shown in FIG. 1b). The instantaneous line voltage from AC source 100 can be rectified, for example, by a diode bridge (not shown in FIG. 1). More specifically, when the instantaneous line voltage of AC source 100 is in a low range 20, the first 121 and the second 122 of two sets of strings of LEDs are configured in parallel as configuration 40 and powered from the instantaneous line voltage of AC source 100. When the instantaneous-line voltage of AC source 100 is in a high range 30, the first 121 and the second 122 of two sets of strings of LEDs are configured in series as configuration 50 and powered from the instantaneous line voltage of AC source 100.

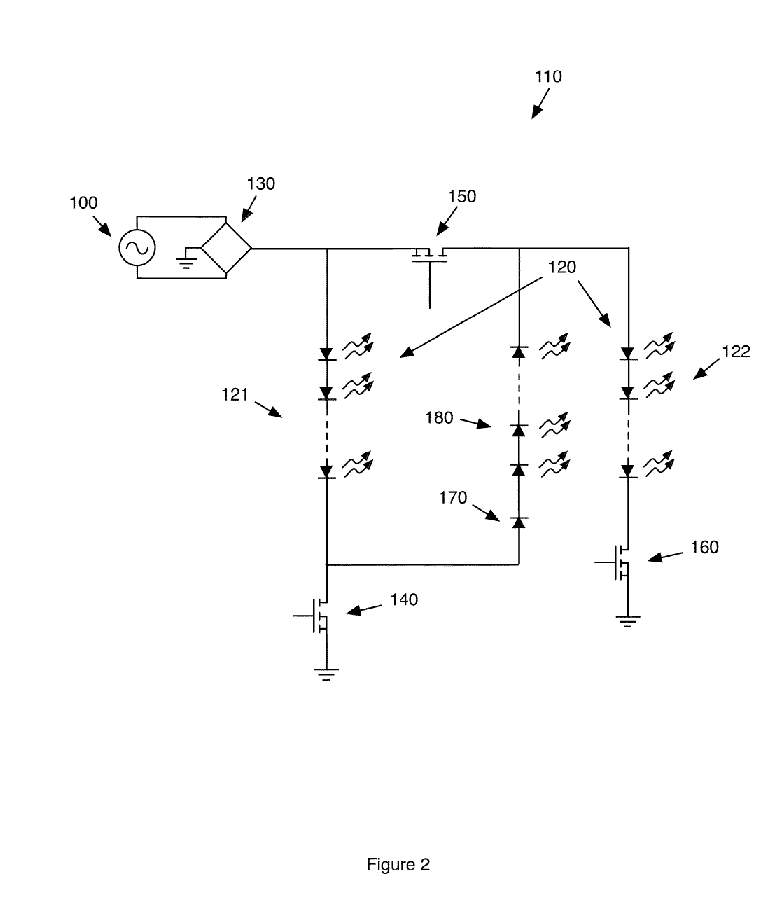

FIG. 2 is a diagram of an AC-line input LED circuit 110, in which two sets of strings of LEDs 120 are configured to re-configure as the instantaneous -line voltage from AC source 100 rises from one range to another. As shown in FIG. 2, the instantaneous line voltage from AC source 100 is rectified by a diode bridge 130. The output voltage of the diode bridge 130 is fed to the first 121 of the two sets of strings of LEDs 120. This first 121 of the two sets of strings of LEDs 120 is connected through a transistor 140 to ground. In other embodiments, the transistor 140 may be replaced by a current sink. Such a current sink can be either a controllable current sink or a non-controllable current sink. The output voltage of the diode bridge 130 is also fed to the transistor 150, and thence to the second 122 of the two sets of strings of LEDs 120. The second 122 of the two sets of strings of LEDs 120 is connected through a transistor 160 to ground, although the transistor 160 need not be present in all cases. In other embodiments, the transistor 160 may be replaced by a current sink. Again, such a current sink can be either a controllable current sink or a non-controllable current sink.

The connection of the first 121 of the two sets of strings of LEDs 120 to the transistor 140 is also connected to a diode 170. The diode 170 is connected to a third set of strings of LEDs 180, although this third set of strings of LEDs 180 may not be present in all cases. The third set of strings of LEDs 180 may instead be replaced or supplemented by one or more resistors and/or one or more zener diodes. The third set of strings of LEDs 180, if present, or the one or more resistors and/or one or more zener diodes, if present, is then connected to the connection between the transistor 150 and the second 122 of the two sets of strings of LEDs 120. If the third set of strings of LEDs 180 is not present, nor the one or more resistors and/or one or more zener diodes, then the diode 170 is instead connected directly to the connection between the transistor 150 and the second 122 of the two sets of strings of LEDs 120.

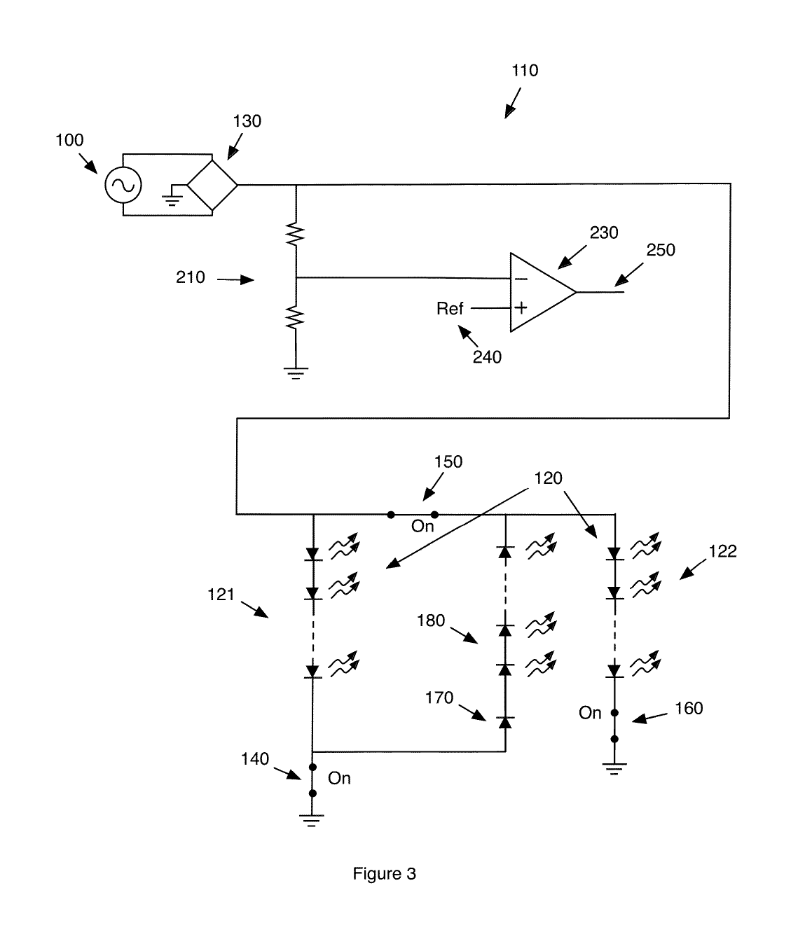

FIG. 3 is a diagram of the AC-line input LED circuit 110 of FIG. 2, operating from a low range of instantaneous line voltage. A control system (e.g., comparator 230) determines the range of the instantaneous line voltage and then controls the controllable elements based on the range of the instantaneous line voltage to re-configured the LED circuit 110, as discussed below.

As shown in FIG. 3, the output voltage of the diode bridge 130 is divided down by a resistor divider 210. The divided down voltage is compared by a comparator 230 with a reference voltage 240. Since the instantaneous line voltage is in the low range, the divided down voltage is lower than the reference voltage 240, and thus the comparator 230 has an output 250 which is high.

When the output 250 of the comparator 230 is high, all three transistors 140, 150, and 160 if present, are in their ‘on’ state, shown as a closed switch. Transistor 140 connects the first 121 of the two sets of strings of LEDs 120 to ground, causing them to experience voltage equal to the line voltage and conduct current. Transistor 150 connects the output voltage of the bridge 130 to the input of the second 122 of the two sets of strings of LEDs 120. Transistor 160 or a current sink, if present, connects the second 122 of the two sets of strings of LEDs 120 to ground. If transistor 160 or a current sink is not present, the second 122 of the two sets of strings of LEDs 120 may be connected directly to ground. As the second 122 of the two sets of strings of LEDs 120 is connected to the output of the bridge 130 and ground, through the transistor 150 which is on, they also experience voltage equal to the line voltage, and so they also conduct current. Since the diode 170 and the third set of strings of LEDs 180 and/or resistors and/or zener diodes has the output of the bridge 130 and ground applied across them, the diode 170 is reverse-biased, and is non-conducting in this situation. In this configuration, the two sets of strings of LEDs 120 are in parallel, thus producing the correct current in each string while the line voltage is in this lower voltage range.

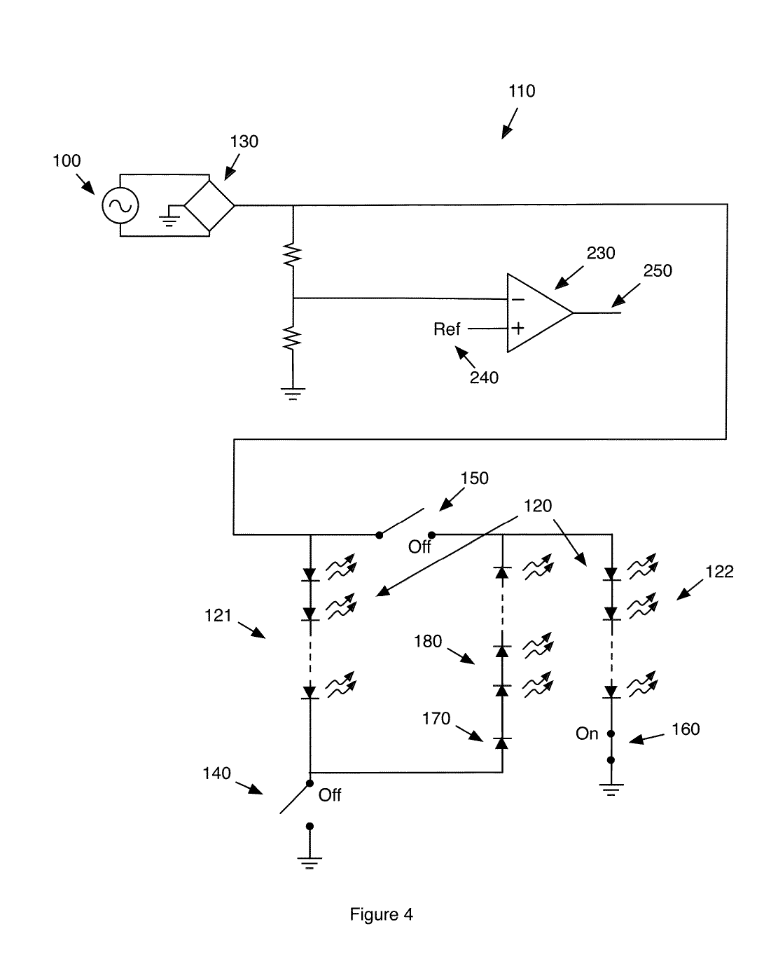

FIG. 4 is a diagram of the AC-line input LED circuit 110 of FIG. 2, operating from a high range of the instantaneous line voltage. As shown in FIG. 4, since the instantaneous line voltage is in the high range, the divided down voltage is higher than the reference voltage 240, and thus the comparator 230 has an output 250 that is low. When the output 250 of the comparator 230 is low, the transistors 140 and 150 are in their ‘off’ state, shown as open switches, while transistor 160 or a current sink, if present, remains in its ‘on’ state, shown as a closed switch. In this condition, current flows through the first 121 of the two sets of strings of LEDs 120, through the diode 170 and the third set of strings of LEDs 180 and/or resistors and/or zener diodes, and thence through the second 122 of the two sets of strings of LEDs 120, and then through the transistor 160 or current sink, if present, which is connected to ground. In this configuration, the two sets of strings of LEDs 120 are in series, thus producing the correct current in each string while the line voltage is in this higher voltage range.

Although the above-discussed embodiment is shown with two possible ranges of the instantaneous line voltage, any number of ranges is possible in other embodiments with an appropriately alternative control system(s). Similarly, although the above-discussed embodiment is shown with two possible LED set configurations, series and parallel, additional configurations are possible in other embodiments. For example, in such alternative embodiments, the additional configurations can include various combinations of LEDs connected in series and LEDs connected in parallel, effectively forming various possible hybrid configurations. Such additional possible hybrid configurations can be implemented, for example, with the alternative control system(s) having more than two ranges of instantaneous line voltage.

It will be apparent that various modifications and variation can be made to the disclosed embodiments. In view of the foregoing, it is intended that the disclosed embodiments cover modifications and variations.

What is claimed is:

1. A line-voltage light emitting diode (LED) driver comprising:
a rectifier;
a first at least one LED connected to one output of said rectifier;
a first controllable element connected in series with said first at least one LED;
a second at least one LED;
a second controllable element from said one output of said rectifier connected to said second at least one LED;
a connection from said second at least one LED to ground;
at least a unidirectional conducting element from said connection of said first controllable element with said first at least one LED to connection of said second controllable element with said second at least one LED; and
a control system controlling said first controllable element and said second controllable element such that both are on while an instantaneous line voltage of the output of the rectifier is in a first, lower range, and both are off while the instantaneous line-voltage is in a second, higher range.

2. A line-voltage LED driver as set forth in claim 1, wherein said rectifier is a diode bridge rectifier.

3. A line-voltage LED driver as set forth in claim 1, wherein said first at least one LED is at least one series string of LEDs.

4. A line-voltage LED driver as set forth in claim 1, wherein said first controllable element is a transistor.

5. A line-voltage LED driver as set forth in claim 1, wherein said first controllable element is a current sink.

6. A line-voltage LED driver as set forth in claim 1, wherein said second at least one LED is at least one series string of LEDs.

7. A line-voltage LED driver as set forth in claim 1, wherein said second controllable element is a transistor.

8. A line-voltage LED driver as set forth in claim 1, wherein said connection from said second at least one LED to ground is a short.

9. A line-voltage LED driver as set forth in claim 1, wherein said connection from said second at least one LED to ground is an element in series with said second at least one LED and connected to ground.

10. A line-voltage LED driver as set forth in claim 9, wherein said connection from said second at least one LED to ground is a transistor.

11. A line-voltage LED driver as set forth in claim 9, wherein said connection from said second at least one LED to ground is a current sink.

12. A line-voltage LED driver as set forth in claim 1, wherein said unidirectional conducting element is a diode.

13. A line-voltage LED driver as set forth in claim 12, wherein said diode is in series with a third at least one LED.

14. A line-voltage LED driver as set forth in claim 13, wherein said third at least one LED is at least one series string of LEDs.

15. A line-voltage LED driver as set forth in claim 14, wherein said at least one series string of LEDs contains fewer LEDs per string than said first or said second at least one LEDs.

16. A line-voltage LED driver as set forth in claim 12, wherein said diode is in series with at least one resistor.

17. A line-voltage LED driver as set forth in claim 12, wherein said diode is in series with at least one zener diode.

18. A line-voltage LED driver as set forth in claim 1, wherein said control system is configured to receive a divided down version of the line voltage and a reference voltage, the control system including a comparator that is configured to compare said divided down version of the line voltage with said reference voltage to determine a state of said first controllable element and said second controllable element.

19. A line voltage LED driver as set forth in claim 18, wherein said divided down version of the line voltage is filtered for noise.

20. An apparatus, comprising:
a plurality of light emitting diodes (LEDs);
a controllable element connected to at least one LED from the plurality of LEDs; and
a current sink connected to at least one LED from the plurality of LEDs,
the controllable element and the current sink collectively having a first configuration and a second configuration, the plurality of LEDs being connected in series when the controllable element and the current sink collectively are in the first configuration, the plurality of LEDs being connected in parallel when the controllable element and the current sink collectively are in the second configuration.

21. An apparatus, comprising:
a plurality of light emitting diodes (LEDs) configured to receive a current;
a controllable element connected to at least one LED from the plurality of LEDs; and
a current sink connected to at least one LED from the plurality of LEDs,
the controllable element and the current sink collectively configured to connect the plurality of LEDs in series when an instantaneous line-voltage of the current is in a first range, the first controllable element and the current sink collectively configured to connect the plurality of LEDs in parallel when the instantaneous line voltage of the current is in a second range less than the first range.
